(19) United States
(12) Patent Application Publication
(10) Pub. No.: US 2025/0069078 A1
(43) Pub. Date: Feb. 27, 2025

(54) RECORDING BLOCKCHAIN TRANSACTIONS

(71) Applicant: WRT Technologies Limited, London (GB)

(72) Inventors: Gerald V.K. LEONG, London (GB); Stephen C. HILL, London (GB); Nick ROBINSON, London (GB); Luc MOREAU, London (GB)

(73) Assignee: WRT Technologies Limited, London (GB)

(21) Appl. No.: 18/721,711

(22) PCT Filed: Dec. 20, 2022
(86) PCT No.: PCT/GB2022/053310

§ 371 Date: Jun. 19, 2024

(30) Foreign Application Priority Data
Dec. 20, 2021 (GB) 2118552.5

(51) Int. Cl. G06Q 20/40; G06Q 20/38

(52) U.S. Cl. CPC G06Q 20/401; G06Q 20/382; G06Q 20/389

(57) ABSTRACT

There is described an apparatus for recording information relating to a blockchain transaction, the apparatus comprising: a communication interface for receiving a transmission associated with a transaction, wherein the transaction is associated with the blockchain; a memory; and a processor for: recording the transaction on the memory; determining provenance information associated with the transaction; and recording the provenance information on the memory; wherein the processor is arranged to determine a network status of the apparatus, wherein: using the communication interface, the apparatus is arranged to record the transaction and/or the provenance information on the blockchain when the apparatus is connected to a network; and/or the apparatus is arranged to record the transaction and/or the provenance information on the memory when the apparatus is not connected to a network.

### FIELD OF THE DISCLOSURE

The present disclosure relates to an apparatus for recording information relating to a blockchain transaction. The disclosure also relates to a blockchain as well as to methods of transmitting information between nodes of the blockchain, methods of configuring the blockchain, and methods of querying the blockchain.

### BACKGROUND OF THE DISCLOSURE

Existing methods and systems for performing transactions typically involve the transfer of fiat currency between two parties in exchange for a good or service. Once the transaction has been completed, there is little to no record of the transaction and its context and the currency can thereafter be used freely. It is difficult to determine whether a transaction involves an undesirable element, such as a corrupt party or a fraudulent document, and even if an undesirable element is identified, it can be difficult to retrieve evidence of the details of the transaction.

### SUMMARY OF THE DISCLOSURE

Aspects and embodiments of the present invention are set out in the appended claims. These and other aspects and embodiments of the invention are also described herein.

According to least one aspect of the present disclosure, there is described an apparatus for recording information relating to a blockchain transaction, the apparatus comprising: a communication interface for receiving a transmission associated with a transaction, wherein the transaction is associated with the blockchain; a memory; and a processor for: determining provenance information associated with the transaction; and determining a network status of the apparatus, wherein: the apparatus is arranged to record the transaction and/or the provenance information on the memory when the apparatus is not connected to a network.

Preferably (e.g. using the communication interface), the apparatus is arranged to record the transaction and/or the provenance information on the blockchain when the apparatus is connected to a network.

Preferably, the apparatus comprises a portable and/or disposable apparatus.

Preferably, the apparatus comprises a coin (e.g. a physical coin).

Preferably, recording the transaction and/or the provenance information on the blockchain comprises transmitting the transaction and/or the provenance information to a node of the blockchain such that the transaction or the provenance information can thereafter be recorded on the blockchain.

Preferably, the processor and/or the communication interface is arranged to record the transaction and/or the provenance information on the blockchain.

Preferably, the communication interface is arranged to transmit the transaction and/or the provenance information to a node of the blockchain.

Preferably, the communication interface is arranged to communicate using a mobile network. Preferably, the communication interface is arranged to communicate using a mobile network when the apparatus is not connected to an area network.

Preferably, the processor is arranged to: determine one or more tokens stored on the memory of the apparatus; determine one or more previous transactions relating to the tokens; and record the transaction in dependence on the combined value of the transaction and the previous transactions being less than the value of the token(s).

Preferably, the processor is arranged to record the transaction in dependence on the provenance information associated with the transaction and/or in dependence on provenance information stored on the memory.

Preferably, the memory is arranged to store smart contract information associated with the blockchain. Preferably, the processor is arranged to record the transaction in dependence on the smart contract information. Preferably, the processor is arranged to record the transaction in dependence on the transaction meeting one or more conditions of the smart contract information.

Preferably, the memory is arranged to store information in dependence on a user input. Preferably, the memory is arranged to store one or more of: smart contract information; one or more tokens associated with the blockchain; and wherein the memory is arranged to store provenance information.

Preferably, the determination of provenance information is dependent on an application associated with the transaction. Preferably, the determination of provenance information is dependent on an application associated with a token used in the transaction. Preferably, the application defines a method of capturing provenance information.

Preferably, each of the tokens has a denomination, wherein the denomination is one of a set of possible denominations.

Preferably, the processor is arranged to: identify a value of the denominations of one or more tokens; identify the value of the transaction; determine whether there is a combination of tokens that is equal to the value of the transaction; and split one of the tokens into a plurality of new tokens of smaller denominations in dependence on said determination.

Preferably, each of the new tokens is associated with the same provenance information as the split token.

According to another aspect of the present disclosure, there is described an apparatus for recording information relating to a blockchain transaction, the apparatus comprising: a processor for: identifying a token associated with the blockchain; identify a denomination of the token; and splitting the tokens into a plurality of new tokens of smaller denominations, wherein each of the new tokens is associated with the same provenance information as the split token.

Preferably, the processor is arranged to determine a combination of tokens that is equal to the value of the transaction, which combination uses the least possible number of tokens.

Preferably, the processor is arranged to: identify one or more further tokens associated with the blockchain; determine a sum of the denominations of the token and the further tokens; and record on the blockchain a new token with a denomination that is equal to the sum of denominations.

Preferably, the new token is associated with the same provenance information as the token and each of the further tokens.

According to another aspect of the present disclosure, there is described an apparatus for recording information relating to a blockchain transaction, the apparatus comprising: a processor for: identifying a plurality of tokens associated with the blockchain; identify a denomination of each token; and recording on the blockchain and/or on a memory of the apparatus a new token with a denomination that is equal to the sum of the denominations of the plurality of tokens; wherein the new token is associated with the same provenance information as the plurality of tokens.

Preferably, the processor is arranged to determine whether a condition has been met. Preferably, the processor is arranged to record the new token in dependence on the condition being met.

Preferably, the condition is associated with one or more of: a number of uses of the token; a value of the token; an age of the token; a value of transactions that have included the token; and an amount of provenance information associated with the token.

Preferably, the processor is arranged to identify one or more further tokens with the same denomination as the token.

Preferably, the processor is arranged to identify one or more further tokens associated with the same party as the token.

Preferably, the processor is arranged to determine a number of uses of the token; and determine whether the number of uses exceeds a threshold number of uses.

Preferably, the processor and/or the communication interface is arranged to record on the blockchain a plurality of new tokens, when the sum of the denominations of the new tokens is equal to the denomination of the token.

Preferably, each of the new tokens is associated with the same provenance information as the token.

Preferably, the set of possible denominations is dependent on a configuration of the blockchain and/or a user input.

According to another aspect of the present disclosure, there is described a method of recording information relating to a blockchain transaction, the method comprising: receiving, at a communication interface of an apparatus, a transmission associated with a transaction, wherein the transaction is associated with the blockchain; determining provenance information associated with the transaction; determining a network status of the apparatus; and recording the transaction and/or the provenance information on a memory when the apparatus is not connected to a network.

Preferably, the method comprises recording the transaction and/or the provenance information on the blockchain when the apparatus is connected to a network.

According to another aspect of the present disclosure, there is described a method of recording information relating to a blockchain transaction, the method comprising: identifying a plurality of tokens associated with the blockchain; identify a denomination of each token; and recording on the blockchain and/or on a memory of an apparatus a new token with a denomination that is equal to the sum of the denominations of the plurality of tokens; wherein the new token is associated with the same provenance information as the plurality of tokens.

According to another aspect of the present disclosure, there is described a computer-implemented method of outputting a transmission to a second node of a blockchain, the method being performed by a first node of the blockchain, the method comprising: receiving, at a communication interface of an apparatus, a transmission associated with a transaction, wherein the transaction is associated with the blockchain; determining provenance information associated with the transaction; determining a network status of the apparatus; and transmitting the provenance information to the second node in dependence on the network status.

According to another aspect of the present disclosure, there is described a computer-implemented method of outputting a transmission to a second node of a blockchain, the method being performed by a first node of the blockchain, the method comprising: identifying a plurality of tokens associated with the blockchain; identify a denomination of each token; and transmitting to the second node a new token with a denomination that is equal to the sum of the denominations of the plurality of tokens; wherein the new token is associated with the same provenance information as the plurality of tokens.

According to another aspect of the present disclosure, there is described a computer program product comprising software code adapted when executed to carry out the aforesaid method.

According to another aspect of the present disclosure, there is described an apparatus arranged to carry out the aforesaid method.

According to another aspect of the present disclosure, there is described a system comprising the aforesaid apparatus and one or more further computer devices, preferably wherein the further computer devices comprise nodes of the blockchain.

The disclosure extends to methods and apparatuses for configuring a blockchain to require the performance (e.g. by a validating node) of the methods disclosed herein.

The invention extends to any novel aspects or features described and/or illustrated herein.

Further features of the disclosure are characterised by the other independent and dependent claims.

Any feature in one aspect of the disclosure may be applied to other aspects of the disclosure, in any appropriate combination. In particular, method aspects may be applied to apparatus aspects, and vice versa.

Furthermore, features implemented in hardware may be implemented in software, and vice versa. Any reference to software and hardware features herein should be construed accordingly.

Any apparatus feature as described herein may also be provided as a method feature, and vice versa. As used herein, means plus function features may be expressed alternatively in terms of their corresponding structure, such as a suitably programmed processor and associated memory.

It should also be appreciated that particular combinations of the various features described and defined in any aspects of the disclosure can be implemented and/or supplied and/or used independently.

The disclosure also provides a computer program and a computer program product comprising software code adapted, when executed on a data processing apparatus, to perform any of the methods described herein, including any or all of their component steps.

The disclosure also provides a computer program and a computer program product comprising software code which, when executed on a data processing apparatus, comprises any of the apparatus features described herein.

The disclosure also provides a computer program and a computer program product having an operating system which supports a computer program for carrying out any of the methods described herein and/or for embodying any of the apparatus features described herein.

The disclosure also provides a computer readable medium having stored thereon the computer program as aforesaid.

The disclosure also provides a signal carrying the computer program as aforesaid, and a method of transmitting such a signal.

The disclosure extends to methods and/or apparatus substantially as herein described with reference to the accompanying drawings.

### BRIEF DESCRIPTION OF THE FIGURES

Aspects and embodiments of the disclosure will now be described, purely by way of example, with references to the accompanying drawings in which:

FIG. 1 shows a system in which two parties wish to make a transaction.

FIGS. 2a and 2b illustrate computer devices on which aspects of the disclosed system may be implemented.

FIG. 3 shows a method of recording provenance information relating to a transaction.

FIG. 4 shows a method of recording provenance information relating to an offline transaction.

FIG. 5 shows a method of splitting a token.

FIG. 6 shows a method of combining tokens.

### DETAILED DESCRIPTION

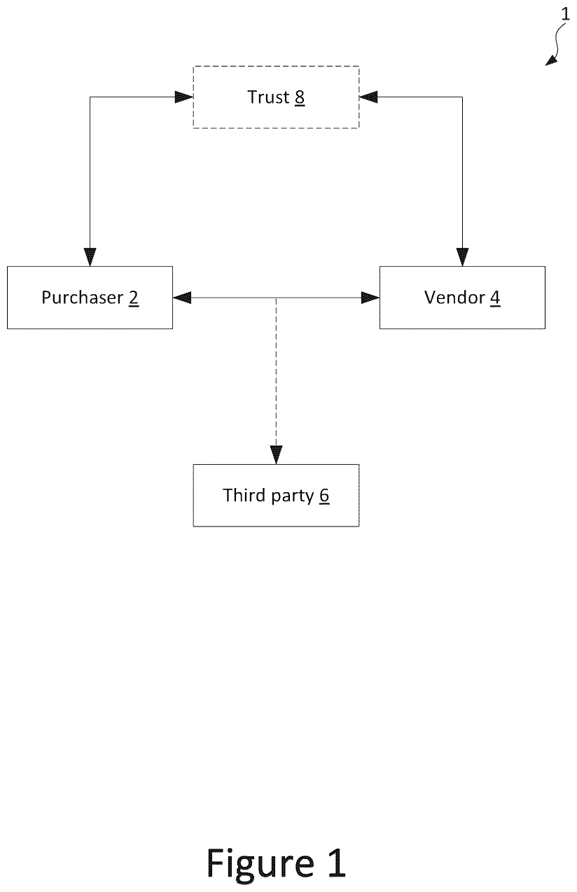

Referring to FIG. 1, there is shown a system 1 in which two parties wish to make a transaction.

To enable the transaction to occur, a purchaser 2 and a vendor 4 are arranged to communicate, either directly or indirectly. The purchaser 2 is able to transfer an amount of a currency to the vendor 4 and in return the vendor 4 is able to transfer a good to, or performs a service for, the purchaser 2.

A third party 6, such as a notary or an investor 6 is able to oversee the transaction. The third party 6 is arranged to communicate with at least one of the companies in order to receive, and optionally verify, information relating to the transaction.

The system 1 also comprises a trust 8. The trust 8 is capable of issuing a digital currency, e.g. a cryptocurrency and/or a virtual currency, in the form of a coin to the purchaser 2. The purchaser 2 can then use this coin to complete the transaction. In order to enable the trust 8 to issue the coin to the purchaser 2, the trust 8 is arranged to communicate either directly or indirectly with the purchaser 2.

The trust 8 is also arranged, either directly or indirectly, to communicate with the vendor 4. After receiving the coin from the purchaser 2, the vendor 4 is able to exchange this coin for fiat currency at the trust 8.

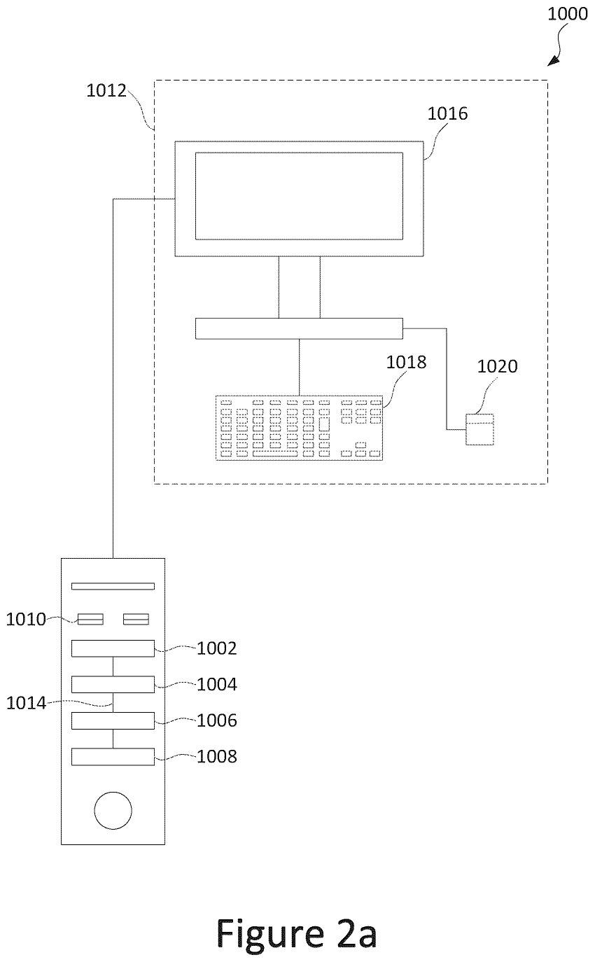

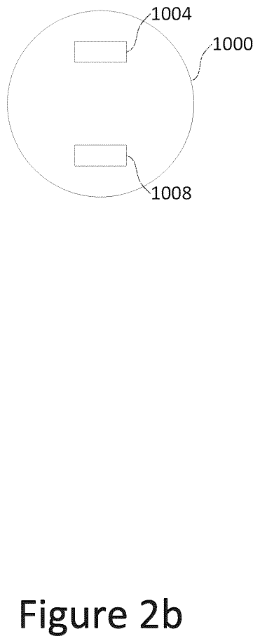

Referring to FIG. 2a, there is shown a computer device 1000 on which aspects of the methods and systems described herein are implemented.

The computer device 1000 comprises a processor 1002, a communication interface 1004, memory 1006, storage 1008, removable storage 1010 and a user interface 1012. These components are arranged to communicate via a bus 1014. The user interface 1012 comprises a display 1016 and an input/output device, such as a keyboard 1018 and a mouse 1020.

The processor 1002 executes instructions, for example instructions stored in the memory 1006, the storage 1008, and/or the removable storage 1010.

The communication interface 1004 facilitates communication between each of the purchaser 2, vendor 4, third party 6, and trust 8. The communication interface may for example comprise an Ethernet connection, an infrared connection, or a Bluetooth® connection.

The communication interface 1004 may comprise a mobile network. In particular where a connection to the internet is not possible, the computer device may be arranged to transmit information via a mobile network. This is particularly useful in areas where internet connections are not possible. In some embodiments, the computer device is arranged to transmit information via sound bursts.

The memory 1006 stores information for use by the processor 1002. Typically, the memory comprises both read-only memory (ROM) and random-access memory (RAM).

The storage 1008 enables long term-storage of information; the storage 1008 typically comprises a hard disk device (HDD) and/or a solid-state drive (SSD).

The removable storage 1010 provides further storage for the computer device 1000. The removable storage may, for example, comprise an interface for a universal serial bus (USB) device. The removable storage 1010 may also comprise online storage, such as a cloud storage account.

Each of the purchaser 2, vendor 4, third party 6, and trust 8 use computer devices 1000 to implement aspects of the methods and systems as described herein. The computer devices 1000 used may be the same, but in most implementations the computer devices 1000 will differ from one another somewhat to suit the different specific purposes and functions of the purchaser 2, vendor 4, third party 6, and trust 8 respectively.

Typically, the third party 6 is interested in recording aspects of transactions. Therefore, the third party 6 may use a device with a large storage capacity, e.g. the storage 1008 is a storage device with large capacity. The computer devices 1000 on which the purchaser 2 and vendor 4 are implemented are typically personal devices, such as personal computers, laptop computers, and tablet computers.

A computer program product is provided that includes instructions for carrying out aspects of the method(s) described below. The computer program product is stored, at different stages, in any one of the memory 1006, the storage 1008, and the removable storage 1010. The storage of the computer program product is non-transitory, except when instructions included in the computer program product are being executed by the CPU 1002, in which case the instructions are sometimes stored temporarily in the CPU 1002 or memory 1006. It should also be noted that the removable storage 1008 is removable from the computer device 1000, such that the computer program product is held separately from the computer device 1000 from time to time. Different computer program products, or different aspects of a single overall computer program product, are present on the computer devices 1000 used by the purchaser 2, vendor 4, third party 6, and trust 8, as evident from the description below.

Different aspects of each party may be operated on a plurality of different computer devices 1000. Further, a plurality of computer devices 1000 may be utilised in the confirmation of a transaction and/or the storage of a transaction ledger. More generally, a combination of computer devices 1000 may be used to store relevant information and carry out aspects of the methods described herein, where these computer devices 1000 may each store copies of the same information, or may store differing information that can be combined.

In some embodiments, aspects of the methods described herein are implemented using blockchain technology and/or a distributed ledger, which are stored upon a plurality of computer devices. This distributed ledger may, for example, store information about the implemented digital currency, which may relate to previous transfers of digital currency and/or current owners of coins to which digital currency is assigned. The purchaser 2, vendor 4, third party 6, and trust 8 may use, at various times, different computer devices 1000 to carry out aspects of the methods, where different computer devices 1000 may have different permissions, so that only on certain systems, or with certain passwords, can a party access certain information and/or system capabilities.

Each of these parties is typically a node of the blockchain and/or the distributed ledger. The nodes of the blockchain may comprise each party that is: connected to, uses, views, validates, proposes blocks for, mines blocks of, adds to, or interrogates the blockchain.

In order to add information to the blockchain, a transaction containing the information is validated by a first node of the blockchain. once the transaction has been validated, the transaction can be included in a block that is proposed for addition to the blockchain. Typically, a plurality of transactions are included in each block. A node that validates transactions may also propose blocks for addition to the blockchain. Equally, different nodes may perform these different functions.

Once the transaction has been included in a proposed block, this block is propagated through the network. If this block receives approval from the other nodes of the blockchain, the block becomes a part of the blockchain. Receiving approval may involve the verification of a consensus mechanism, such as a proof of work consensus mechanism or a proof of stake consensus mechanism. For example, a node may need to solve a proof of work problem before proposing a block, where the addition of the block to the blockchain is dependent on a valid solution to this proof of work problem being provided.

In some embodiments, each node has access to separate records on the blockchain. However, typically, the distributed ledger is accessible by every party (although this ledger may contain information that not every party can view). There may also be certain data that is held solely on the computer device 1000 of a subset of the nodes.

The blockchain is arranged to store information relating to the transactions that occur in the system 1, such as a transaction amounts and transaction participants. This typically involves receiving information via the communication interface 1004 of the computer device 1000 used by each party, where a party that wishes to make a transaction (e.g. the purchaser 2) submits this transaction to a node of the blockchain.

Typically, a transaction relates to a transfer of an object between two parties (e.g. the purchaser 2 transferring a coin to the vendor 4). More generally, a transaction may relate to any change in the state of an object on the blockchain, which change in state can be validated and then included in a proposed block. In an example, the purchaser 2 may transmit a transaction that indicates the purchaser has moved from a first location to a second location. This change in the location of the purchaser can then be recorded in a block and stored on the blockchain.

The transmission of a transaction may require manual input from a user. Equally, a transaction may be transmitted to a node of the blockchain by a computer device. So the phone of the purchaser 2 may identify a change in location via a GPS interface and may then transmit a transaction that indicates this change in location so that a user of the blockchain can identify the change in the location of the user and the time of the change in location (based on a timestamp of a block of the blockchain that contains the relevant transaction).

Referring to FIG. 2b, there is shown an alternative embodiment of a computer device on which the methods and systems disclosed herein may be disclosed.

As shown in FIG. 2b, the computer device may be a portable computer device, and may be implemented on an apparatus that is similar to a physical coin (or a card). With such a portable computer device, the communication interface 1004 may comprise a near-field communication (NFC) chip to enable the apparatus to receive and transmit information. Transmissions received by the near-field communication chip may be used to power the apparatus (e.g. the apparatus may operate based on passive NFC) so that the coin may not have an internal power supply.

The apparatus is typically portable so that it can be carried by a person. In an exemplary use, the apparatus may be used to store an amount of cryptocurrency (e.g. a private address associated with the cryptocurrency may be stored in the storage 1008 of the computer device of the apparatus) so that a person can carry the apparatus to a shop and use the cryptocurrency to pay for a good. This payment may utilise the NFC chip. This apparatus then offers a simple and user-friendly way to transmit information (e.g. to make payments).

It will be appreciated that the disclosures herein may be implemented using a non-portable computer device and/or a portable computer device. Certain aspects of the disclosures may require substantial computing power, these aspects are typically performed using a non-portable computer device with a powerful CPU or GPU and substantial cooling capabilities. Other disclosures may benefit from a portable computer device; for example, the portable computer device of FIG. 2a is useful where data needs to be carried, and transmitted, in areas without an available internet connection.

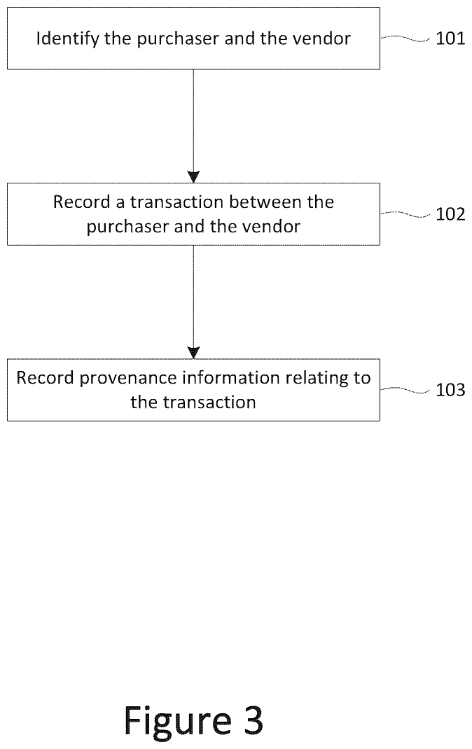

Referring to FIG. 3, there is described a method of using the computer device to record a transaction. More specifically, the method is typically performed by a node of the blockchain, where the transaction may be transmitted to this node by another node of the blockchain.

In a first step 101, the computer device identifies a purchaser and a vendor. More generally, the computer devices identifies a sending node and a receiving node (e.g. the node may identify two accounts of an account model blockchain and/or two UTXOs of a UTXO model blockchain).

This identification is typically based on a transaction received by the node. In a practical example, the purchaser 2 may initiate a payment by placing a portable computer device (as described with reference to FIG. 2) next to an NFC reader. The portable computer device and/or the NFC reader may then transmit a transaction to a node of the blockchain, where this transaction identifies the purchaser, the vendor 4, and a transaction amount. It will be appreciated that this transaction need not be a purely financial transaction and that more generally the transaction may be associated with the recording of information on the blockchain (e.g. information confirming the sale).

In a second step 102, the computer device records a transaction between the purchaser 2 and the vendor 4. Typically, this comprises proposing a block for addition to the blockchain that contains the transaction. Equally, the computer device may validate the transaction so that a separate computer device is able to propose a block including the transaction.

In a third step 103, the computer device records provenance information relating to the transaction.

The provenance information may be included as a part of the transaction that is recorded on the blockchain. Equally, some or all of the provenance information may be recorded separately to the transaction. For example, some of the provenance information may be stored on a separate database. This enables the blockchain to be used as a public record of the transactions and certain provenance information, with other provenance information (e.g. personally identifying information) being stored in a private record.

Provenance information relates to the chronology of the ownership, custody and location of objects (e.g. those objects involved in a transaction); specifically, provenance information provides contextual and circumstantial evidence for the original production or discovery of an entity, and the subsequent sequence of its formal ownership, custody and location. This provenance information may therefore be used to assess aspects of the transaction following the completion of the transaction.

The blockchain (and/or the apparatus or computer device) may require the recording of provenance information. Similarly, the blockchain may be configured to require the recording of blockchain information. More generally, any of the method steps herein may be required for the recording of information on the blockchain, where these steps may be required by a validation requirement of the blockchain. For example, the blockchain may be configured so that transactions that do not contain provenance information are invalid (and therefore nodes of the blockchain cannot or will not validate such transactions). Therefore, the disclosures herein may relate to a method of configuring the blockchain to require the performance of the described method steps (e.g. to require this performance in order to obtain a valid transaction).

Typically, the recording of provenance information comprises the recording of one or more provenance parameters. Exemplary provenance parameters that may be recorded include:

### Descriptive Parameters

‘Who’: who are the parties to the transaction? This parameter can, for example, relate to named companies (e.g. Seller: “Example Company”; Buyer “Acme Corporation) or pseudonyms (e.g. Seller: “Company A”, Buyer “Company B”). In some embodiments, the ‘who’ parameter relates to pseudonyms, where only trusted parties are informed of the real company behind each pseudonym. Further, any party may only be aware of a subset of the pseudonymous companies. As an example, an investor of Acme Corporation may be informed that “Example Company” has made a transaction to “Company B”.
‘Where’: where was the transaction performed? This parameter can, for example, relate to a geographic location (e.g. this parameter can include GPS co-ordinates); an event (e.g. “at the annual shareholder meeting”); or a medium (e.g. on the internet).
‘When’: when was the transaction performed? Typically, this parameter includes a date and/or time. The parameter might also include a related event (e.g. “at the annual shareholder meeting”).
‘What’: what is the object of the transaction? This parameter relates to the goods or services that are the subject of the transaction. This parameter can include an indication of any currency transferred and any good/service transferred. For example, ‘what’ may record “£300 is to be transferred in return for service X”.
‘How’: how is the transaction performed? This parameter typically includes an indication of the method of currency transfer and/or transfer of goods. For example, ‘how’ may record “bank transfer”.

### Interpretive Parameters

‘How’: separately to the descriptive ‘how’ parameter, the interpretive ‘how’ parameter typically indicates the conditions that led to the transaction taking place. For example, ‘how’ may record that the CEOs of “Example Company” and “Acme Corporation” met at a conference in March, had a meeting in April, and closed a deal in May. By examining the interpretive ‘how’ parameter, a party is able to determine how a transaction came to take place. This is thus useable to determine whether a deal is wholly “above board”, or whether there might have been some underhanded business practices taking place. As an example, “how” might indicate that “Example Company” and “Acme Corporation” had been on bad terms at the conference and yet following a one-on-one unrecorded meeting the CEOs had agreed a deal with favourable terms for one of the companies. This might suggest (when other factors are considered) that the meeting involved bribery.
‘Why’: similarly to ‘how’, why indicates the reasons behind the transaction taking place. This parameter may, for example, record that a politician had been campaigning for a bridge to be built for some time and had finally obtained enough support; hence, there is a transaction for a bridge to be built. ‘Why’ may also contain an assessment of the reasoning behind a feature of the transaction, for example ‘why’ might record that a key supporter had only agreed to back the bridge after receiving a number of gifts from the politician.

Further examples of provenance information that might be recorded are described in WO2021/099802.

The computer device may be arranged to determine one or more of these parameters; for example, the computer device may be arranged to determine the ‘why’ parameter.

Determining a parameter may comprise receiving a user input. For example, the computer device may be arranged to prompt the user for an input at the time of recording a transaction and to thereafter receive a user input. This may comprise the user selecting a parameter from a limited set of possible parameters (e.g. the reasons for ‘why’ may include: “donations”, “rent”, “travel”, “expenses”, etc.).

In some embodiments, the computer device is arranged to determine the ‘why’ parameter in dependence on the ‘how’ parameter. In this regard, the computer device may determine the ‘why’ parameter based on a payment method and/or system (e.g. depending on a point of service (POS) associated with a transaction.

In some embodiments, the computer device is arranged to determine a parameter based on a parameter of a previous transaction; for example, the computer device may determine that a similar transaction has occurred previously and deduce that a current transaction has occurred for the same reason.

The computer device is typically arranged to determine when a transaction has occurred and to determine a timing of this transaction and/or a timing of a transaction in relation to a timing of a separate event (where this separate event may be determined based on a transmission received by the computer device). Therefore, a transaction can be linked closely to an event. In an example, where a transaction is made for a good and a “Good is loaded into truck” notification is received in relation to this transaction, then the computer device is able to identify that the transaction relates to both the purchase of a good and a delivery of that good and so this transaction may be more expensive than expected for the good.

The provenance parameters may be determined based on artificial intelligence and/or machine learning. In particular, the parameters may be based on artificial intelligence and/or machine learning that takes into account past behaviour of a user and/or of the computer device.

In some embodiments, the computer device is arranged to receive information (e.g. text and/or image information) from the environment so that an investigator can later interrogate this information if an audit is required. For example, if a transaction involves buying a bicycle from John Smith, the bicycle shop owner, at 112 Kensington High Street, the Coin may capture the information that John Smith was the 2012 Olympic medal winner. This information may be used in combination with artificial intelligence and/or machine learning algorithms.

In some embodiments, the provenance information is determined automatically, where a prompt is generated for any information that cannot be automatically determined by the computer device (e.g. because this is the first purchase of a certain type of good).

Typically, the provenance information comprises information associated with an Electronic Product Code Information Services (EPCIS) event. In particular, the provenance information may be determined based on the identification of an EPCIS event.

Provenance information may be determined based on one or more of:
Commission—An event signifying the creation of an object (or a token). An example, the birth of piglets in a pork value chain or the minting of a token (e.g. a token associated with an amount of cryptocurrency).
Transformation—An event signifying an irreversible transformation of an object or a token. An example would be slaughtering of the pigs into carcasses or transferring a UTXO.
Aggregation—An event signifying grouping of objects or tokens. For example, batching of the pigs for transportation or receiving a plurality of UTXOs at a single address.
Disaggregation—An event signifying the ungrouping objects to a smaller group or individual objects. For example, separation of the pigs or the spending of the UTXO to a plurality of other UTXOs.
Observation—An event signifying an observation, such as quality testing of the carcasses or an evaluation of a UTXO.
Decommission—An event signifying deletion of an object. Carcasses that do not pass the quality test may be discarded or tokens with certain features may be locked.
Payment: EPCIS events typically do not account for payments, while the provenance information of the present disclosure typically comprises payment information.

In some embodiments, the token comprises a pointer to an application, where the recording of provenance information is dependent on the pointer/application. Therefore, when the token is spent (or transferred), the provenance information is recorded based on the pointer and/or the application. This enables the token to capture the requisite provenance information and also enables the application to identify that the token has been spent. The use of the application enables the methods of capturing provenance information, and the types of provenance information that are required, to be defined by the application.

In an example, the token may be issued by a hotel for use in that hotel. The token may then include a pointer to an application that records provenance information depending on a use of the token. So if the token is used in a hotel restaurant, the application may instruct a camera in that restaurant to take a picture so as to verify a user of the token (and this user may then be recorded on the blockchain via the provenance information). By enabling the token to comprise a pointer to an application, different users of the blockchain can define different methods of recording provenance information that are suitable for the ecosystems in which the token is to be used.

Typically, the blockchain is configured such that the tokens of the blockchain are programmable for additional relationships not allowed under the w3c library of relationships. More generally, the tokens may be useable to record an entity, an activity, and an agent as part of the provenance information (these terms are known in the w3c PROV standards).

The present disclosure relates in part to an apparatus that can be used for offline transactions as well as a method of recording transactions offline and also a method of recording prior offline transactions on the blockchain. The apparatus (and the portable computer device) described with reference to FIG. 2b is particularly suited to use for offline transactions, where this apparatus may be carried by a user into areas without reliable network connections (e.g. remote villages). The apparatus may then be used to perform offline transactions that can be recorded on the blockchain once the computer device of the apparatus reconnects to a network.

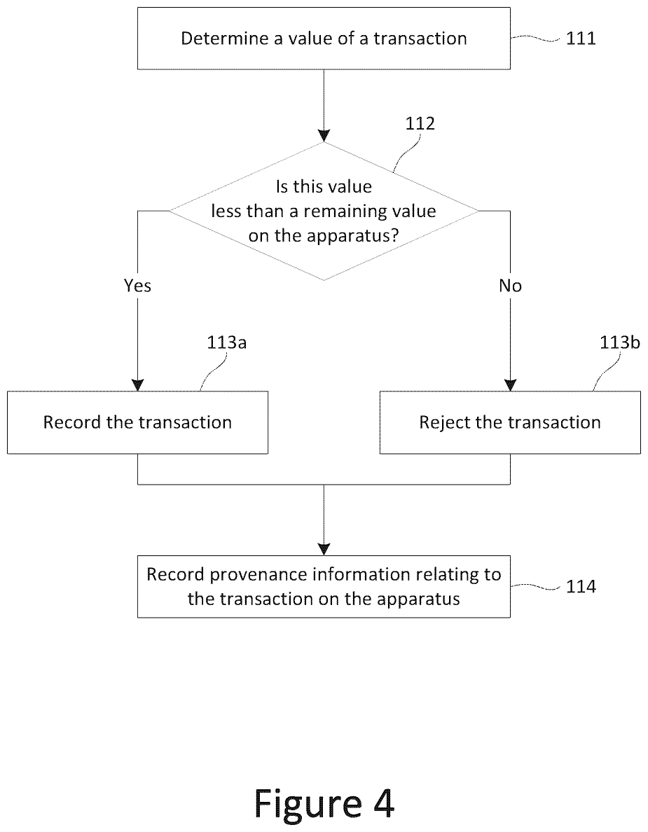

Referring to FIG. 4, there is described a method of recording information for an offline transaction, where the method is performed by a computer device (e.g. the computer device of the apparatus). The method may be performed by the portable apparatus of FIG. 2b (or a similar apparatus). Equally, this method may be performed by a non-portable apparatus with which the portable apparatus interacts. For example, the portable apparatus may be used to initiate a transaction with a fixed device (e.g. a payment terminal), where this method may be performed by the payment terminal.

In a first step 111, the computer device determines a value of a transaction.

In a second step 112, the computer device determines whether the value of the transaction is less than a remaining value on the computer device.

In this regard, the portable computer device is typically arranged to store an amount of token (e.g. a token associated with an amount of cryptocurrency) that is suitable for use in more than one transaction. Where the portable computer device is able to connect to a network, each transaction may be recorded as soon as it occurs. Where a UTXO blockchain is used, a transaction results in the sending UTXO expiring, so that any subsequent transactions must use another UTXO. Where an account model blockchain is used, the account can then be reused.

Where offline transactions occur, the blockchain cannot be immediately updated or immediately queried. Therefore, the (portable) computer device is typically arranged to maintain a record of all online transactions and to maintain a record of a total spend associated with these online transactions in order to ensure that the total spend does not exceed a total value associated with the computer device. This total value may relate to a total value of assets (e.g. cryptocurrency) held by the owner of the computer device and/or may relate to a value of tokens held in an offline container (e.g. an offline wallet).

When the computer device reconnects to a network, each of the offline transactions may be recorded on the blockchain. Where a UTXO blockchain is used, this may comprise a single transaction being recorded with a plurality of recipients.

In a positive third step 113a, if the value of the transaction is less than a value remaining on the computer device then the computer device records the transaction.

In a negative third step 113b, if the value of the transaction is less than a value remaining on the computer device then the computer device rejects the transaction.

In a fourth step 114, the computer device records provenance information relating to the transaction.

The method described with reference to FIG. 4 enables transactions to be performed even when no network connection is available. These transactions can then be recorded on the blockchain once a network connection becomes available.

A potential concern with offline transactions is that the undesirable transactions may be performed offline since it is not possible to immediately query these transactions with reference to the blockchain. The blockchain may comprise a smart contract that limits the use of token, for example a child may be limited to spending a token on textbooks—such limitations can be difficult to enforce with offline transactions.

The recording of provenance information on the apparatus enables transactions to be recorded or rejected in dependence on a feature of the transaction and/or previous transactions.

In particular, the computer device that is performing the method may determine a provenance parameter that is associated with the computer device and/or the token being used for the payment. The method may comprise recording and/or rejecting the transaction in dependence on this provenance parameter. Furthermore, the method may comprise updating this provenance parameter.

For a similar reason, the apparatus may be arranged to store smart contract information so that it is available for offline use. This smart contract information can then be used to evaluate any transactions that are attempted while the apparatus is offline.

Typically, accounts and/or tokens of the blockchain are associated with provenance information, which provenance information may be recorded on the blockchain or may be recorded in a separate datastore. In particular, the provenance information may be stored in a datastore that is associated with a wallet containing a token. In practice, a user may control a wallet that contains a plurality of tokens; each token may be associated with certain provenance information and the wallet may also be associated with certain provenance information.

This provenance information may be transferred to, and stored on, the apparatus while the apparatus is online so that the provenance information can be evaluated and/or updated if the apparatus is used for an offline transaction.

The provenance information that is transferred to, and/or stored on, the apparatus may be selected by the user and/or may be dependent on the context of a transaction. Therefore, when a user moves between jurisdictions (e.g. crosses borders), the user is able to carry the apparatus, which stores a token as well as a subset of the provenance information that is associated with the token. This can be used to improve security (since the user may not wish to carry certain types of provenance information into certain jurisdictions).

Exemplary systems and methods for storing different types of information in different datastores have been described in detail in WO2021/099802.

Provenance information associated with any transactions that occur while the apparatus is offline is recorded on the apparatus so that when the user returns to the initial jurisdiction the user is able to re-establish a connection to a network and to record this provenance information on the blockchain and/or on another datastore.

In particular, the computer device of the apparatus may be arranged to determine whether it is possible to connect to a network and to synchronise provenance information and/or transactions with the blockchain and/or another datastore in dependence on the determination. The determination of whether it is possible to connect to a network is typically dependent on the availability of a network connection (e.g. the presence of a local area network). This determination may also be dependent on a user input; for example, a user may decide not to connect to a network even if a network is available. Typically, this would happen where a user is not comfortable with the security of the available networks.

Synchronising transactions typically comprises determining whether the transactions stored on the apparatus have been recorded on the blockchain. When the apparatus has been offline, these transactions will not be recorded until the apparatus regains a network connection. Therefore, the apparatus is arranged to record the offline transactions once the network connection is regained.

As has been described above, provenance information may be stored on the blockchain and/or may be stored in on another datastore. A synchronisation process for provenance information involves determining whether the provenance information stored on the apparatus is recorded on the blockchain and/or the datastore and, if the provenance information is not recorded on the blockchain and/or the datastore, recording this information on the blockchain and/or datastore.

As described above, typically the information stored on the apparatus is a subset of the information stored on the blockchain and/or the datastore. Therefore, the synchronising of information may further comprise determining further provenance information to fill in any gaps. For example, the datastore may store information on the context of a transaction (e.g. the ‘why’ or the ‘how’ of a transaction), where this information may not be recorded on the apparatus when offline transactions take place (since the information might be sensitive). A user is then prompted to divulge this information when the apparatus returns online so that the datastore is complete.

The apparatus may be arranged to store provenance information that is not recorded on the blockchain. This additional provenance information expands the number of uses of the apparatus.

Typically, the apparatus is arranged to be disposable and/or low value. This enables a user to transfer the apparatus as part of a transaction (where a user would be unwilling to hand over a high value apparatus such as a computer as part of a potentially low value transfer of tokens). The apparatus may also be small (e.g. have a volume of less than 0.001m³) and/or flexible, so as to easily fit in a pocket.

### Denominations

The blockchain that is used to record the transactions may be arranged to record transactions associated with a number of unique (e.g. non-fungible) tokens. Such a system can be used to implement a system with denominations. For example, a first token may be associated with a value of $1, and a second token may be associated with a value of $5. It will be appreciated that various systems of valuation, and various denominations may be used.

Typically, the blockchain is arranged so that each token is associated with a specific denomination of a limited set of denominations. In an exemplary implementation, each token may be associated with a denomination that is one of: 1¢ (1 cent or $0.01), 5¢, 10¢, 25¢, 50¢, $1, $2, $5, $10, $20, $50, and $100.

The use of specific denominations enables the blockchain to be tied in a straightforward manner to a real-world ecosystem (so that the tokens can be used to track provenance information). Furthermore, the use of specific denominations avoids a combinatorial explosion of provenance information that could be caused if increasingly small values of tokens were traded.

A wallet (or the apparatus) typically holds a plurality of tokens of different denominations, so that transactions can be completed using appropriate tokens. For example, a transaction for $8 may involve a single token of $5 and three tokens of $1. Denominations may be applied using either a UTXO blockchain or an account model blockchain. With a

UTXO blockchain, each token is associated with a different UTXO, so this exemplary transaction involves three UTXOs. Each UTXO is typically transferred to a different output address, so that the tokens remain separate following the transactions (as opposed to being combined into a single UTXO).

The blockchain may be arranged so that tokens can be split. For example, a token with a denomination of $5 is typically able to split into five tokens of $1. This enables users to perform transactions of various values.

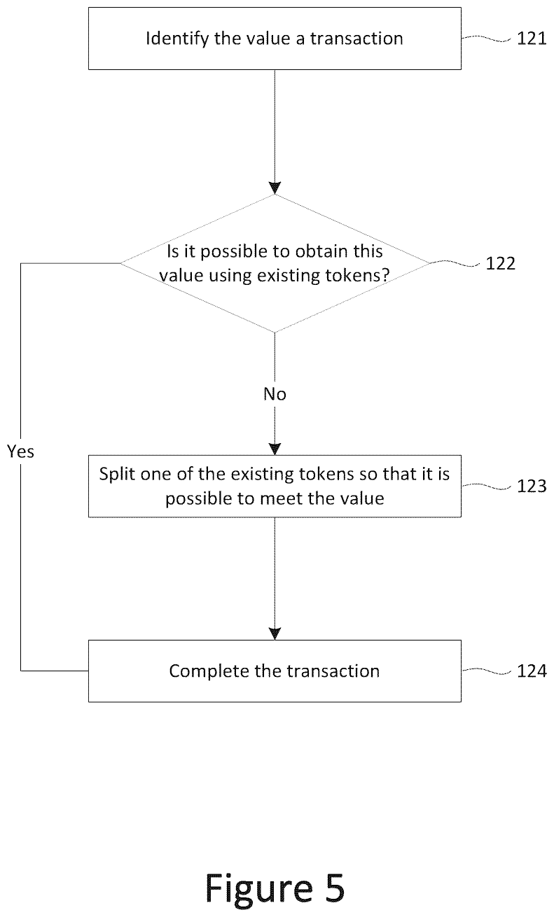

Referring to FIG. 5, a method of splitting a token is described. This method is typically carried out by a computer device (e.g. that of the apparatus).

In a first step 121, the computer device identifies a value of a transaction. For example, a holder of the token may be attempting to buy a good with a value of $1.23.

In a second step 122, the computer device determines whether it is possible to obtain this value using existing tokens. As described above, each token is typically associated with a fixed denomination. For example, the user may hold tokens with denominations of $1, tokens with denominations of $0.20 and tokens with denominations of $0.05. In such a situation, the user may have enough funds to complete the transaction, but may not be able to obtain the required value.

This determination may use algorithms, machine learning, artificial intelligence, brute force methods etc. In particular, the computer device may determine a combination of tokens that obtains the value using the fewest possible tokens.

If the value can be obtained using existing tokens, then in a fourth step 124 the computer device completes (e.g. records) the transaction. As described above, this typically comprises completing the transaction using the fewest possible number of tokens. This minimises the amount of provenance information that must be recorded.

In a third step 123, if the value cannot be obtained using existing tokens, the computer device splits one or more of the existing tokens so that it is possible to meet the value. For example, the computer device may split a token with a denomination of $0.05 into five tokens of $0.01. The computer device then completes the transaction.

Splitting a token typically comprises issuing a plurality of new tokens and locking the old token. With a UTXO blockchain, splitting a $0.05 token may comprise transferring $0.01 into five new addresses.

Each of the new tokens is typically associated with the same provenance information as the old token. Continuing with the example of a UTXO blockchain, this association may be that the new tokens are linked via a transaction on the blockchain to the old token.

Where the transaction occurs offline, the apparatus may store a record of the splitting of tokens until a network connection is available, at which point the splitting can be recorded on the blockchain.

In some embodiments, a party configuring the blockchain is able to define the denominations to be used.

Typically, (separate) provenance information is associated with each token. Where the token is split, the provenance information may be cloned and associated with each of the ‘child’ tokens. Therefore, the provenance of each child token may be traced back via the ‘parent’ token.

Over time large denomination tokens will be split into parts in order to perform various transactions. This carries the risk of combinatorial explosion, where the amount of provenance stored rapidly grows (since each token is associated with provenance information, the use of many small tokens requires the recording of more information than the use of a single large token).

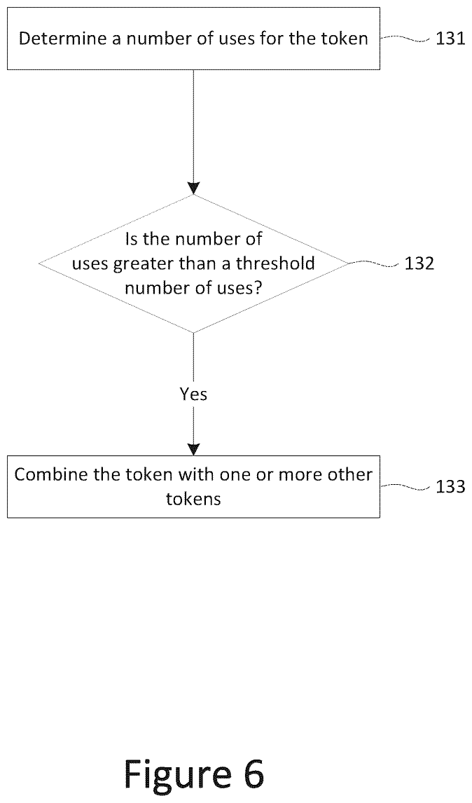

Therefore, with reference to FIG. 6, a method of combining tokens is described. This method is carried out by a computer device, e.g. one of the nodes of the blockchain.

In a first step 131, the computer device determines a number of uses for the token. This typically comprises determining a number of transactions that have included the token.

In a second step 132, the computer device determines whether the number of uses of the token is greater than a threshold number of uses.

In a third step 133, if the number of uses exceeds the threshold number of uses the computer device combines the token with one or more other tokens. This typically comprises issuing a new token that is equal in value to the tokens being combined.

It will be appreciated that a number of other conditions may be assessed, with the combination of the tokens being dependent on one or more of these conditions being met. For example, the computer device may determine an amount of provenance information associated with the token, an age of the token (in seconds and/or in a number of blocks), a value of transactions that have included the token etc.

This method may be performed periodically, frequently, based on an event, and/or after each use of the token. For example, the method may be performed when the token is transferred to the apparatus and/or when the apparatus leaves or enters a certain area.

Typically, the token is associated with a user and is combined with other tokens associated with the same user. Therefore, the method may be performed when the user is associated with a plurality of tokens that exceed the use threshold. This is not least because typically the possible denominations of a token are limited (so combining a $1 token may require four other $1 tokens to provide a $5 token).

The combination of tokens may require each token to have the same denomination. Equally, it may be possible to combine tokens of different denominations.

When tokens are combined, a new token is typically issued. This new token may reference each of the previous tokens. For example, each of the previous tokens may be transferred to a single address of a UTXO blockchain to provide a new token. In this situation, the new token still comprises a reference to the provenance information of each of the old tokens. Therefore, no provenance information is lost by the combination of tokens.

Equally, when the tokens are combined the provenance information associated with each of the old tokens may be removed from a datastore in order to minimise the required data storage.

By combining tokens as described above, the amount of data storage required can be substantially reduced, since instead of needing to store provenance information multiple times in relation to a plurality of tokens, provenance information can be stored a single time (e.g. where a £50 token is used instead of ten £5 tokens, provenance information needs to be stored once as opposed to ten times).

The storage of provenance information may depend on a number of uses of a token. More specifically, when a token has been used a number of times that is above a threshold number, the provenance information may be removed and/or the recording of new provenance information may be halted. In an example, a £1 token may be used for ten transactions, with provenance information for each transaction being added to the token after that transaction has occurred. After the tenth transaction, the token may be combined with other tokens (as described above) and/or disassociated from the previously recorded provenance information. The old provenance information will still be stored on the blockchain, but may not be directly associated with the token when the token is used for subsequent transaction. In this regard, the tokens are typically non-fungible due to their association with provenance information, since this provenance information typically limits the possible uses of the token. Disassociating the provenance information from the token transforms a token into a fungible token where this provenance information no longer limits the uses of the token.

The number of uses before disassociation of provenance information may be set by a user of the token and/or by a controller of the ecosystem (e.g. a bank that issues tokens).

In some embodiments, tokens can be defined as ‘tracer’ tokens, where tracer tokens are arranged to be immune from combination or from the disassociation of provenance information. Tracer tokens are thus able to carry provenance information for an extended period of time and can be used to track long chains of transactions (this is useful where, say, the 100^{th} transaction using a token still has some connection to the 1^{st} transaction). Tracer tokens may record different provenance information to other tokens, in particular tracer tokens may record only certain provenance parameters.

The creation of a tracer token typically comprises a user input, for example a user may record a transaction on the blockchain, which transaction sets a flag that defines the token as a tracer token. The creation of the tracer token may depend on the token having been used a threshold number of times (e.g. a token may need to be involved in seven transactions before it can be defined as a tracer token). Similarly, a token may need to comprise a certain amount and/or type of provenance information to be set as a tracer token.

It will be appreciated that where a token is described as being used in a plurality of transactions, this may comprise multiple linked components tokens being used. In particular, where a UTXO blockchain is used the ‘token’ may comprise a plurality of different UTXOs that are used in subsequent, linked, transactions. Provenance information may be included in each transaction, where the deletion of provenance information may comprise setting a flag in a transaction that indicates subsequent UTXOs should not be associated with the provenance information of previous, linked, UTXOs. With an account model blockchain, a token may comprise a unique identifier that is referenced in a transaction, where subsequent transactions may also reference this identifier so that the token can be tracked through the blockchain via these references.

As well as provenance information, the token (and/or a tracer token) may be arranged to record provenience information. Provenience information indicates a location (e.g. a block of the blockchain) at which information was discovered. Therefore, the tracer token may indicate when the tracer token was defined so that users are able to rapidly identify this point (e.g. block) of definition.

### Alternatives and Modifications

Various other modifications will be apparent to those skilled in the art for example, for example, the portable computer device may comprise a coin-shaped device that can be carried in a user's pocket. Similarly, the portable computer device may comprise a note, e.g. a graphene-based note.

It will be understood that the present invention has been described above purely by way of example, and modifications of detail can be made within the scope of the invention. For example, while the detailed description has primarily described methods and systems with reference to blockchain, the disclosures herein are more generally applicable to any distributed ledger technology and/or public consensus network.

In some embodiments, the computer device is arranged to receive biometric information. In particular, the computer device may receive biometric information from each of a sender and a recipient and transfer ownership of a token from the sender to the recipient in dependence on this biometric information (so that the sender may, for example, provide their fingerprint to verify a transaction).

The computer device may determine provenance information based on this biometric information. For example, a name of a user may be determined based on their fingerprint.

Reference numerals appearing in the claims are by way of illustration only and shall have no limiting effect on the scope of the claims.

1. An apparatus for recording information relating to a blockchain transaction, the apparatus comprising:
a communication interface for receiving a transmission associated with a transaction, wherein the transaction is associated with the blockchain;
a memory; and
a processor for:
determining provenance information associated with the transaction; and
determining a network status of the apparatus, wherein:
the apparatus is arranged to record the transaction and/or the provenance information on the memory when the apparatus is not connected to a network.

2. The apparatus of claim 1, wherein using the communication interface, the apparatus is arranged to record the transaction and/or the provenance information on the blockchain when the apparatus is connected to a network.

3. The apparatus of claim 1, being a portable and/or disposable apparatus.

4. The apparatus of claim 1, wherein recording the transaction and/or the provenance information on the blockchain comprises transmitting the transaction and/or the provenance information to a node of the blockchain such that the transaction or the provenance information can thereafter be recorded on the blockchain.

5. The apparatus of claim 1, wherein:
the processor and/or the communication interface is arranged to record the transaction and/or the provenance information on the blockchain; and/or,
the communication interface is arranged to transmit the transaction and/or the provenance information to a node of the blockchain.

6. (canceled)

7. The apparatus of claim 1, wherein the communication interface is arranged to communicate using a mobile network when the apparatus is not connected to an area network.

8. The apparatus of claim 1, wherein the processor is arranged to:
determine one or more tokens stored on the memory of the apparatus;
determine one or more previous transactions relating to the tokens; and
record the transaction in dependence on the combined value of the transaction and the previous transactions being less than the value of the token(s).

9. The apparatus of claim 1, wherein the processor is arranged to record the transaction in dependence on the provenance information associated with the transaction and/or in dependence on provenance information stored on the memory.

10. The apparatus of claim 1, wherein the memory is arranged to:
store smart contract information associated with the blockchain, wherein the processor is arranged to record the transaction in dependence on the smart contract information; and/or
store information in dependence on a user input, wherein the memory is arranged to store one or more of: smart contract information; one or more tokens associated with the blockchain; and wherein the memory is arranged to store provenance information.

11. The apparatus of claim 1, wherein the determination of provenance information is dependent on an application associated with the transaction.

12. The apparatus of claim 1, wherein each of the tokens has a denomination, wherein the denomination is one of a set of possible denominations.

13. The apparatus of claim 1, wherein the processor is arranged to:
identify a value of the denominations of one or more tokens;
identify the value of the transaction;
determine whether there is a combination of tokens that is equal to the value of the transaction; and
split one of the tokens into a plurality of new tokens of smaller denominations in dependence on said determination;
preferably wherein each of the new tokens is associated with the same provenance information as the split token.

14. An apparatus for recording information relating to a blockchain transaction, the apparatus comprising:
a processor for:
identifying a token associated with the blockchain;
identify a denomination of the token; and
splitting the tokens into a plurality of new tokens of smaller denominations,
wherein each of the new tokens is associated with the same provenance information as the split token.

15. The apparatus of claim 14, wherein the processor is arranged to determine a combination of tokens that is equal to the value of the transaction, which combination uses the least possible number of tokens.

16. The apparatus of claim 14, wherein the processor is arranged to:
identify one or more further tokens associated with the blockchain;
determine a sum of the denominations of the token and the further tokens; and
record on the blockchain a new token with a denomination that is equal to the sum of denominations.

17. The apparatus of claim 16, wherein the new token is associated with the same provenance information as the token and each of the further tokens.

18. An apparatus for recording information relating to a blockchain transaction, the apparatus comprising:
a processor for:
identifying a plurality of tokens associated with the blockchain;
identify a denomination of each token; and
recording on the blockchain and/or on a memory of the apparatus a new token with a denomination that is equal to the sum of the denominations of the plurality of tokens;
wherein the new token is associated with the same provenance information as the plurality of tokens.

19. The apparatus of claim 1, wherein the processor is arranged to determine whether a condition has been met wherein the processor is arranged to record the new token in dependence on the condition being met.

20. The apparatus of claim 19, wherein the condition is associated with one or more of: a number of uses of the token; a value of the token; an age of the token; a value of transactions that have included the token; and an amount of provenance information associated with the token.

21. The apparatus of claim 1, wherein the processor is arranged to identify one or more further tokens with the same denomination as the token and/or wherein the processor is arranged to identify one or more further tokens associated with the same party as the token.

22-32. (canceled)
